(19) United States
(12) Patent Application Publication
(10) Pub. No.: US 2014/0368910 A1
(43) Pub. Date: Dec. 18, 2014

(54) FOG-PROOF DEVICE

(71) Applicant: Ingrasys Technology Inc., Taoyuan (TW)

(72) Inventor: SHU-YUN HUANG, Taoyuan (TW)

(73) Assignee: INGRASYS TECHNOLOGY INC., Taoyuan (TW)

(21) Appl. No.: 14/049,221

(22) Filed: Oct. 9, 2013

(30) Foreign Application Priority Data
Jun. 14, 2013 (TW) 102121037

(51) Int. Cl. G02B 27/00

(52) U.S. Cl. CPC G02B 27/0006
USPC 359/512

(57) ABSTRACT

A fog-proof device for evaporating fog from a camera's lens includes a glass covering a front surface of the lens, and a light-shielding cylinder mounted to the glass. The light-shielding cylinder defines a through hole. A zigzagging heat-generating portion is formed along a circumference of the light-shielding cylinder, and two ends of the heat-generating portion are separated by a gap. Ends of the heat-generating portion at opposite sides of the gap are electrically connected to two power wires.

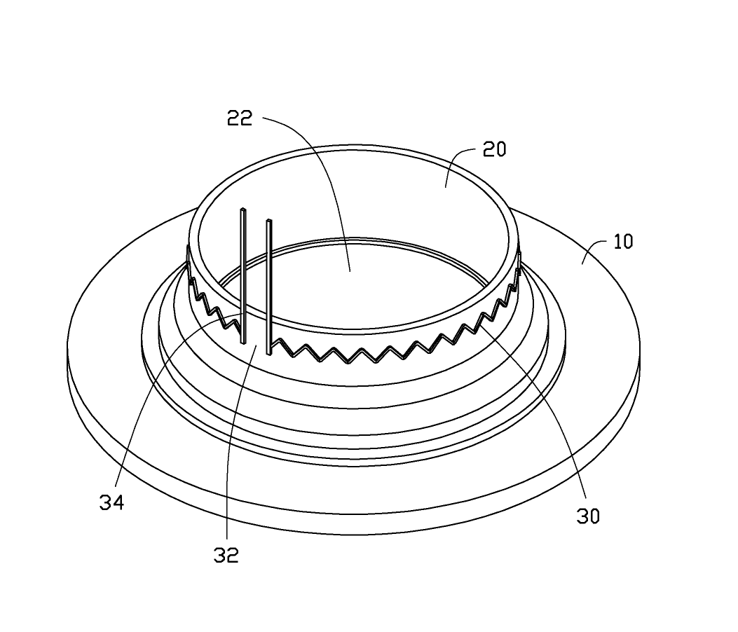

### BACKGROUND

1. Technical Field

The present disclosure relates to a fog-proof device for a camera.

2. Description of Related Art

Lenses of cameras often get foggy in high humidity or when the temperature changes too quickly. As a result, photos captured by the lens cones of the cameras are not as clear as they should be.

### BRIEF DESCRIPTION OF THE DRAWING

Many aspects of the present embodiments can be better understood with reference to the following drawing. The components in the drawing are not necessarily drawn to scale, the emphasis instead being placed upon clearly illustrating the principles of the present embodiments. Moreover, in the drawing, the view is schematic, and like reference numerals designate corresponding parts throughout the single view.

The FIGURE is an isometric view of an embodiment of a fog-proof device.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

The FIGURE shows an embodiment of a fog-proof device for evaporating fog from a lens of a camera. The lens includes a glass 10 covering a front surface of the lens, and a light-shielding cylinder 20 mounted to the glass 10. The light-shielding cylinder 20 defines a through hole 22 in a center thereof to receive a lens cone (not shown) of the lens. The fog-proof device includes a zigzagging heat-generating portion 30 that is etched along a circumference on a surface of the light-shielding cylinder 20. A gap 32 is defined, which separates two ends of the heat-generating portion 30. Ends of the heat-generating portion 30 at opposite sides of the opening 32 are electrically connected to two power wires 34. The power wires 34 are electrically connected to a circuit board of the camera (not shown) to conduct power to the heat-generating portion 30, and the heat-generating portion 30 generates heat to evaporate fog from the glass 10.

In this embodiment, the heat-generating portion 30 is made of copper.

In other embodiments, the heat-generating portion 30 may be formed on an external surface of the light-shielding cylinder 20, or be inlayed along the circumference of a surface the light-shielding cylinder 20.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A fog-proof device for camera's lens, comprising:
a glass of the lens;
a light-shielding cylinder mounted to the glass and defining a through hole;
a heat-generating portion formed along a circumference of the light-shielding cylinder, a gap is defined between opposite ends of the heat generating portion; and
two power wires electrically connect to the opposite ends of the heat-generating portion at opposite sides of the gap.

2. The fog-proof device of claim 1, wherein the heat-generating portion is made of copper.

3. The fog-proof device of claim 1, wherein the heat-generating portion is zigzag.

4. The fog-proof device of claim 1, wherein the heat-generating portion is etched along the circumference of a surface of the light-shielding cylinder.
